(19) United States
(12) Patent Application Publication
(10) Pub. No.: US 2008/0304480 A1
(43) Pub. Date: Dec. 11, 2008

(54) Method for Determining the Forwarding Direction of Ethernet Frames

(76) Inventor: Torsten Langguth, Unterhaching (DE)

Correspondence Address: BELL, BOYD & LLOYD, LLP, P.O. BOX 1135, CHICAGO, IL, 60690, US

(21) Appl. No.: 11/795,467

(22) PCT Filed: Jan. 3, 2006
(86) PCT No.: PCT/EP06/50011

§ 371 Date: Jul. 24, 2008

(30) Foreign Application Priority Data
Jan. 18, 2005 (DE) 10 2005 002 358.4

(51) Int. Cl. H04L 12/56

(52) U.S. Cl. 370/389

(57) ABSTRACT

A method and switch for determining the routing direction of Ethernet frames in order to route them to a destination, e.g. a computer, by means of Ethernet switches, according to which a frame is received by a first switch are provided. The first switch determines that the source address of the frames is not a destination address that has been registered in the switch for the routing of frames. The source address is registered by the first switch as a new destination address for the routing of frames. The first switch then communicates the new destination address to a second Ethernet switch and when the destination address has been received, the second switch defines a routing direction for the frames to the new destination in the destination address.

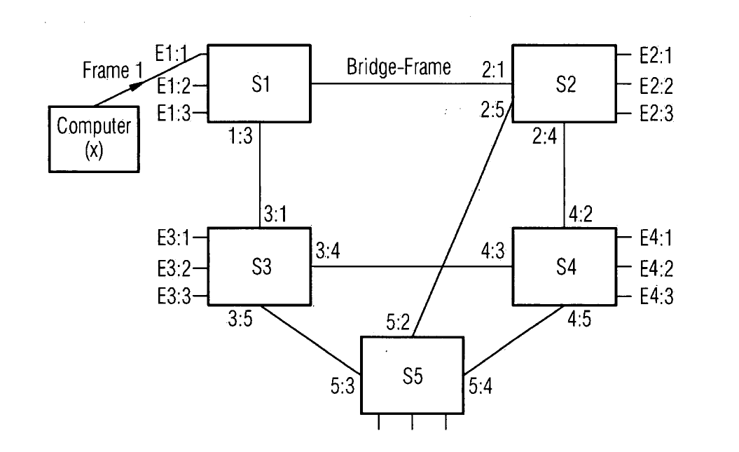

The invention relates to a method for determining the forwarding direction of Ethernet frames for their onward routing to a destination, and an Ethernet switch adapted to carry out such a method.

Ethernet technology which is generally used in Local Area Networks (LANs) is currently being refined for use in Metro networks. In order to be able to implement the network quality necessary for required services, in refining Ethernet networks every effort must be made above all to achieve high availability (fail-safe). As ring topologies (loops) are often employed in the Metro network area, and simple loops are very fault-prone—a cable breakage or loose connector normally resulting in network failure or overload—high availability must also be provided in ring architectures.

Of particular interest for high availability is the mechanism for determining the forwarding direction in Ethernet switches. A switch examines every passing frame—the term packet is also used in the literature—to determine the destination MAC address (MAC: Media Access Control) and forwards it directly in the corresponding direction. For this purpose a self-learning mechanism is generally used which extracts the source address from all the incoming frames. Traffic to a learned address is generally transmitted via the port at which the frame from which the source address was extracted was received. If no forwarding information is available, flooding generally takes place, i.e. the frame is transmitted to all the ports associated with the corresponding network segment. This makes network dimensioning, traffic engineering and the maintenance of quality of service difficult.

A known method used in Ethernet networks is STP (Spanning Tree Protocol). This allows timer controlled switching of an Ethernet switch to another port for frame forwarding, but can only achieve relatively long switching times/outage of some 30-45 seconds for a recommended configuration and 8-12 seconds for an optimized configuration. In addition, as the avoidance of loops is based on port blocking in the case of the STP method, the complete network capacity is not therefore available during normal operation.

With RTSP (Rapid Spanning Tree Protocol) outage times can be reduced. The outage time is dependent on network size. In addition, flooding is generally performed directly after fault clearance, which may result in quality of service impairment.

Also known are ring-based loop avoidance methods such as EAPS (Ethernet Automatic Protection Switching), RRSTP (Riverstone's Rapid Spanning Tree) or patented methods of Siemens AG (DE 10 004 432) and Siemens AG/Hirschmann (DE 298 20 587). With these methods the loop in the ring is broken in a privileged switch, known either as a redundancy manager or master, by blocking a line.

By means of regular signaling messages, the consistency of the ring is checked and the blocked port is re-opened if necessary. In addition to this fault detection, the other switches can report faults and perform local switching. However, these methods require a ring structure which cannot always be assumed in Metro networks. Here too the above described flooding also occurs after the interruption. A corresponding quality of service in conjunction with high availability cannot therefore be ensured. Port blocking means that the full network capacity is likewise unavailable during normal operation.

The common feature of all these methods is that, because of port blocking, distribution of the network load is not possible during normal operation. New methods from Nortel Networks (MLT, Multi Line Trunking) and 3COM (XRN, Expandable Resilient Networking) avoid this problem through the continuous exchange of the complete forwarding database (FDB) between the switches. This exchange naturally results in a significantly higher network load. Moreover, because of the pairwise design, these methods are only suitable to a limited extent for access topologies.

The object of the invention is to determine a forwarding direction of Ethernet frames for their onward routing to a destination while avoiding the disadvantages of conventional methods.

This object is achieved according to the invention by a method having the features set forth in claim 1. Advantageous developments of the present invention will emerge from the dependent claims.

To achieve this object, a method for determining the forwarding direction of Ethernet frames for their onward routing to a destination, e.g. the terminal, by means of Ethernet switches is presented, wherein a frame is received by a first switch. The first switch determines that the source address of the frame is not a destination address registered in the switch for frame forwarding. The source address is registered in the first switch as a new destination address for frame forwarding. The new destination address is communicated by the first switch to a second Ethernet switch and, when the destination address has been received, a forwarding direction is determined by the second switch for the onward routing of frames to the destination specified by the new destination address.

This method is usually executed in a network, e.g. a Metro network. The network comprises e.g. a plurality of Ethernet switches. The first switch is then the network switch by which the frame is received first. Such a switch generally has at least one edge port, i.e. a port at which no information is received from other network switches. Because the frame is received at this port, the first switch can detect that it is the first network switch to receive the frame. The second switch can likewise communicate or notify the new destination address to another Ethernet switch. The new destination address is communicated to all the network switches apart from the first switch by notification by a neighboring switch in each case, e.g. by means of bridge frames. A bridge frame is a frame which is transmitted between the two switches and conveys information e.g. concerning the destination address of the frame whose forwarding direction is to be determined or the address of a switch. This then has a similar function to the configuration BPDUs (Bridge Protocol Data Units) defined in IEEE Standard 802.1. When the destination address is received at a switch, a forwarding direction is determined by the network switches for the transmission of frames to the destination specified by the new destination address and the destination address is communicated to the neighboring switches.

As the network topology is such that a switch can have a plurality of neighboring switches, during propagation of the new destination address in the network a plurality of notifications with the destination address are frequently received by a switch. This switch can then register a plurality of forwarding directions and evaluate them in accordance with metric information. For this purpose, during communication metric information and/or address information relating to the first switch, e.g. Ethernet address, is communicated to a neighboring switch along with the destination address. For determination of a forwarding direction by a switch which receives a bridge frame, there are then e.g. the two following approaches:
The bridge packet contains the destination address and metric information. The switch then registers the direction from which the bridge frame was received as the forwarding direction which is evaluated by means of the metric information.
The bridge packet contains the destination address and the address of the first switch. If the network topology is known to the switch, the optimum route in terms of the metric and possibly alternate routes can be determined and the associated forwarding direction registered. Although this approach places more stringent requirements on the switch, it has the advantage that optimum routes can be determined when a bridge packet is received. Further bridge packets communicating the same address can then be discarded.

A forwarding database for registering a plurality of forwarding directions can be provided in each switch. This allows rapid local switching of the forwarding direction of a frame in the event of a fault at a switch, as alternate routes for forwarding the frame are available. The metric information may refer to hop counts and/or transmission costs for transmission between network switches. Therefore, on the basis of the metric information, an optimum route for forwarding a frame to a destination can be selected from all the registered forwarding directions. For the same the metric, distribution to all the equivalent ports in respect of the metric or selection of one of the ports can take place. Selection can take place automatically or be determined for each configuration. As an automatic selection method, for example, the port via which the address information is first received can be selected. The address information can be evaluated to determine routes or alternate routes which constitute replacement routes in the event of switch failure. A forwarding decision can be made for unicast, multicast and broadcast traffic. For unicast traffic, the forwarding decision is based on the destination address and the corresponding registration in the forwarding database. Forwarding of multicast and broadcast traffic generally only takes place for frames which are received via the port with the lowest metric for the source address. Multicast or broadcast frames received via other ports are deleted.

According to one embodiment of the invention, an abort criterion is specified in respect of the propagation of the notifications concerning the destination address in order to limit the signaling load within the network. For example, the destination address is not communicated to a neighboring switch if the received destination address was send from the neighboring switch or if an abort criterion relating to the transmission of the destination address is met in respect of the neighboring switch. The abort criterion can be that the destination address is not communicated to a neighboring switch if a notification concerning the reachability of the destination address has already been sent to the neighboring switch with more favorable metric information.

With the method according to the invention, a special function is assumed by the switch which first registers the new destination and then communicates it further to one or more switches. The uniqueness of this switch means that situations resulting in flooding of frames in conventional methods can be avoided. The switch is identified e.g. via the port, namely an edge port, at which an Ethernet frame with an unknown address is received. In respect of this address the switch then possesses initiator functionality, i.e. is an initiator switch in the sense that notification of the new address to other switches is imitated by the imitator switch. It is advisable for any removal of the address to be likewise initiated by the initiator switch, the removal being time-controllable by the initiator switch as in the case of conventional Ethernet. The address is removed after a specifiable time interval if no frames to be forwarded to the address are received within the time interval. However, this aging function is performed only by the initiator. If a frame is removed, all the other switches are again informed thereof by bridge frame.

A development of the invention is the transfer of initiator functionality whereby the destination address of a frame which is received at an edge port of the first switch and has already been received previously at another edge port of another switch is communicated by the first switch to the second switches if transfer of initiator functionality to the first switch is required. The other switch is notified by the first switch and registers the destination address as a destination address which requires forwarding of the frames to another network switch. That is to say, the first switch becomes the new initiator switch and communicates to the other switch, which comprises another edge port, the acceptance of initiator functionality, or the switching of the forwarding direction for frames to be sent to the destination address. The other switch, i.e. the old initiator switch, removes the registration as initiator switch and now only retains the forwarding information. If, on the other hand, switching is not required, such a frame received at the edge port of the first switch can be ignored by the first switch.

If a forwarding direction is not to be specified for a frame with a destination address, it is advisable to no longer forward the frame but to remove it, thereby avoiding frame flooding.

With this method it is advantageous that the self-learning/determining of the forwarding direction is not restricted any longer to the path or route but is distributed throughout the network. This means that all the relevant forwarding information (e.g. destination address) is known in all the switches and fast switching to alternate paths is possible, i.e. enabling no-break operation of a network in the event of failure of individual or a small number of network components (e.g. switches, lines). This results in very short switching times which are independent of the network dimension. In addition, the load can be distributed over a plurality of paths. No port blocking occurs, i.e. the entire network capacity is fully available. As the forwarding information is known, flooding can be dispensed with. No additional traffic is therefore generated. Quality of service is unimpaired. The method allows high-availability Ethernet use in access networks with different topologies such as rings and cascades. The method is characterized by its efficiency, speed and autonomy and therefore constitutes a significant advance compared to the known methods.

The invention will now be described in greater detail below with reference to an example and an accompanying drawing.

The FIGURE shows five switches (S1, S2, S3, S4, S5) of a network as well as a computer connected to the edge port E1:1 of the switch S1, said computer being identified with an Ethernet address X. Other edge ports, e.g. E1:2, E1:3, for the switch S1 and E2:1, E2:2, E3:2 for the switch S2 etc. are shown. If switch S1 receives from the computer via the edge port E1:1 a frame whose source address X is not yet present in the forwarding database of S1, this address is incorporated in the database. The switch S1 is then the so-called initiator for routing to the address X. Explicit forwarding information is then provided to the associated neighboring switches, namely switch S2 and switch S3, in a bridge frame. This bridge frame here contains e.g. information concerning the address X and the address of switch S1. The switches S2 and S3 evaluate the received bridge frames, add the entries to the forwarding database and likewise send bridge frames to all the other ports of the corresponding network segment. For example, the switch S2 would process the information received from the switch S1 and forward it to the switches S4 and S5. The bridge frames contain a field which identifies the path length which is described e.g. by means of the hop count (number of hops) or connection costs. Thus the switch S4 would be able to infer from the bridge frame from switch S2 that a frame forwarded to the address X requires two hops within the network via the switch S2. After inclusion in the forwarding database, the switch S4 sends the bridge frames to the switches S3 and S5. At the switch S3, forwarding information for the frames to be sent to the address X via two different ports is present. Via the port 3:1 the destination is reachable with a hop count of 1 within the network, via the port 3:4 the destination can be reached with a hop count of 3 within the network. Both entries are incorporated in the database. In addition, the load can be distributed over paths having the same metric (e.g. port 4:2 and 4:3 to switch S4). The bridge frames continue to be forwarded by the switches until there is no need for forwarding in the corresponding direction. For example, the switch S4 would not forward received information via port 4:5 (hop count 3) to the switches S3 and 2 if the information concerning the shortest directions had already been forwarded via switch S2 (hop count 2) and S3 (hop count 3).

If network faults are detected, the switches change their forwarding tables and forward the corresponding information to the other switches. In the event of failure of switch S2, e.g. switch S3 and switch S5 notify that the hop count has changed from 2 (switch S2 direction) to 3 (switch S4 direction).

1.-14. (canceled)

15. A method for determining the forwarding direction of Ethernet frames for their onward routing to a destination via a plurality of Ethernet switches having a first switch and a second switch, the method comprising:
receiving a frame by said first switch;
determining that a source address of said frame is not registered in said first switch as a destination address for frame forwarding;
registering said source address in said first switch as a new destination address for frame forwarding;
communicating said new destination address from said first switch to said second switch;
receiving said new destination address by said second switch; and
determining a forwarding direction by said second switch for frame forwarding to a destination specified by said new destination address.

16. The method as claimed in claim 15, further comprising:
communicating said new destination address from said second switch to a third switch;
receiving said new destination address by said third switch; and
determining a forwarding direction by said third switch for frame forwarding to said destination specified by said new destination address,
wherein the plurality of Ethernet switch further comprises said third switch.

17. The method as claimed in claim 16,
specifying a network, said network comprising said plurality of Ethernet switches;
communicating said new destination address to all of the plurality of Ethernet switches apart from the first switch by communicating said new destination address to a neighboring switch, and
receiving said new destination address by said neighboring switch; and
determining a forwarding direction by said neighboring switch for frame forwarding to said destination specified by said new destination address,

18. The method as claimed in claim 3,
wherein the destination address is communicated to a neighboring switch unless said destination address was received from said neighboring switch or an abort criterion relating to a transmission of the destination address is met in respect of said neighboring switch.

19. The method as claimed in claim 18, wherein said abort criterion includes a notification concerning the reachability of said destination address with a more favorable metric has already been sent to said neighboring switch.

20. The method as claimed in claim 15, wherein a plurality of forwarding directions are registered and evaluated in accordance with metric information.

21. The method as claimed in claim 20, wherein metric information is communicated along with said new destination address.

22. The method as claimed in claim 21, wherein said metric information metric relates to hop counts or connection types.

23. The method as claimed in claim 21, wherein said metric information metric relates to hop counts and connection types.

24. The method as claimed in claim 15, wherein address information of the first switch is communicated along with said new destination address.

25. The method as claimed in claim 15, wherein said first switch is a network switch by which said frame was first received.

26. The method as claimed in claim 25,
wherein edge ports of network switches are ports at which no information is received from other network switches,
wherein said first switch (S1) incorporates an edge port, and
wherein said frame arrives at said edge port of said first switch whereby said first switch detects that it said network switch to first receive said frame.

27. The method as claimed in claim 26, wherein said frame received at said edge port of said first switch which has already been received at another edge port is ignored by said first switch.

28. The method as claimed in claim 27, wherein said new destination address of a frame received at said edge port of said first switch and which has already arrived at another edge port of another network switch is communicated by said first switch to said second switch and said second switch registers said new destination address as a destination address requiring frame forwarding to another network switch.

29. An Ethernet switch, comprising
a first edge port for communicating between the switch and outside the network; and
a first port for communicating between the switch and second Ethernet port within said network,
wherein a frame having a source address is received via the first edge port,
wherein said source address is registered as a new destination address for frame forwarding in response to said source address not being registered,
wherein said new destination address is communicated via the first port to said second switch, where the said second switch determines a forwarding direction for frame forwarding to a destination specified by said new destination address.
